(19) United States
(12) Patent Application Publication
(10) Pub. No.: US 2010/0329204 A1
(43) Pub. Date: Dec. 30, 2010

(54) Method and Apparatus for Handling Scheduling Information Report in Wireless Communication System

(76) Inventors: Yu-Hsuan Guo, Taipei City (TW); Meng-Hui Ou, Taipei City (TW); Li-Chih Tseng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/825,352

(22) Filed: Jun. 29, 2010

Related U.S. Application Data
(60) Provisional application No. 61/221,091, filed on Jun. 29, 2009.

(51) Int. Cl. H04W 72/04

(52) U.S. Cl. 370/329

(57) ABSTRACT

A method for handling scheduling information report in a user equipment of a wireless communication system includes triggering a scheduling information report to generate a corresponding Medium Access Control Control Element (MAC CE), and keeping and not canceling all triggered scheduling information report(s) when the MAC CE is included in a MAC protocol data unit to be transmitted to a network terminal of the wireless communication system on a contention based uplink resource.

### CROSS REFERENCE TO RELATED APPLICATIONS

This application claims the benefit of U.S. Provisional Application No. 61/221,091, filed on Jun. 29, 2009 and entitled “Method and apparatus for improving MBMS reception and Contention Based transmission in a wireless communication system”, the contents of which are incorporated herein by reference.

### BACKGROUND OF THE INVENTION

1. Field of the Invention

The present invention relates to a method and apparatus for handling scheduling information report, and more particularly, to a method and apparatus capable of ensuring that uplink resources are correctly allocated and maintaining uplink transmission efficiency in a user equipment of a wireless communication system.

2. Description of the Prior Art

Long Term Evolution wireless communications system (LTE system), an advanced high-speed wireless communications system established upon the 3G mobile telecommunications system, supports only packet-switched transmission, and tends to implement both Medium Access Control (MAC) layer and Radio Link Control (RLC) layer in one single communication site, such as in Node B alone rather than in Node B (NB) and RNC (Radio Network Controller) respectively, so that the system structure becomes simple.

According to the current specification (3GPP TS 36.321 V8.6.0), when a user equipment (UE) has uplink data to be transmitted, a buffer status reporting procedure is triggered to output a buffer status report (BSR) to a network terminal, to inform the network terminal about the amount of data available for transmission in an uplink (UL) transmission buffer of the UE. After the BSR is triggered, if the UE has UL resources allocated to a new transmission for a current Transmission Time Interval (TTI), the UE MAC layer instructs a multiplexing and assembly procedure to generate a BSR Medium Access Control Control Element (MAC CE), which is included in a MAC Protocol Data Unit (PDU), such that information about the amount of data in the UL buffers can be reported. Accordingly, the network terminal can determine the total amount of data available across one or all logical channel groups. On the other hand, if there is no available uplink transmission resources at the moment, the UE may further trigger a Scheduling Request (SR) procedure to request the network terminal to allocate uplink transmission resources, which causes user plane delay.

In order to reduce the user plane delay, a next generation of the LTE system, i.e. LTE Advanced (LTE-A) system, introduces Contention Based (CB) transmission, which allows synchronized UEs to contend for uplink transmission resources without sending SRs in advance. However, a general property of the CB transmission is that the error rate may increase due to data packet collision. Therefore, in order to realize the CB transmission, the LTE-A system further introduces a Contention Based Radio Network Temporary Identifier (CB-RNTI), for identifying CB uplink grants allocated by a network terminal to a UE on a Physical Downlink Control Channel (PDCCH). Correspondingly, the UE should generate a unique UE identifier, and include the unique UE identifier in a MAC Protocol Data Unit (PDU), which is transmitted to the network terminal on a CB uplink resource, such that the UE can be identified.

The prior art has not yet specified contents of the MAC PDU transmitted on a CB uplink resource. From a perspective of system design, the MAC PDU can further include a BSR, for reporting an uplink buffer status of the UE to the serving network terminal, such that the network terminal can effectively allocate radio resources and perform scheduling decisions. However, in the prior art, all triggered BSRs should be cancelled when a BSR is included in a MAC PDU. Under such a condition, since the CB transmission may increase the error rate due to data packet collision, the MAC PDU including the BSR may not be successfully transmitted to the network terminal on a CB uplink resource. Besides, the UE may simultaneously perform SR procedure when transmitting the MAC PDU including the BSR. In other words, the UE can receive a more reliable uplink grant requested by the SR procedure later. However, since all triggered BSRs have been cancelled, the UE has no BSR MAC CE available to be transmitted to the network terminal, such that the network terminal cannot determine a buffer status of the UE, causing delay of uplink resource allocation or reduction of uplink transmission efficiency.

On the other hand, the MAC PDU transmitted on a CB uplink resource can include a Power Headroom Report (PHR) with information about power headroom as well. The power headroom is the difference between the UE maximum transmission power and the estimated power for UL-SCH transmission. The UE triggers a PHR when one of the following triggering events occurs: (1) when a prohibit PHR timer “PROHIBIT_PHR_TIMER” expires and a path loss of the UE has changed more than a specific value “DL_PathlossChange” since the last transmission of a PHR if the UE has UL resources for new transmission; (2) a periodic PHR timer “PERIODIC_PHR_TIMER” expires; and (3) upon configuration or reconfiguration of the power headroom reporting functionality by upper layers. After the PHR is triggered, if the UE has UL resources allocated by the network terminal for a new transmission for this TTI, and the UL resources are able to accommodate a PHR MAC CE, the UE MAC layer obtains the value of the power headroom from the physical layer, and instructs the multiplexing and assembly procedure to generate a PHR MAC CE, so that the PHR is reported to the network terminal on the UL-SCH resource. Besides, when a PHR is included in a MAC PDU, all triggered PHRs should be cancelled. Therefore, when a PHR is used in the CB transmission, there is also an issue of delaying uplink resource allocation, or reducing uplink transmission efficiency.

### SUMMARY OF THE INVENTION

It is therefore an objective of the present invention to provide a method and apparatus for handling scheduling information report.

The present invention discloses a method for handling scheduling information report in a user equipment (UE) of a wireless communication system. The method includes steps of triggering a scheduling information report, to generate a corresponding Medium Access Control Control Element (MAC CE), and keeping and not canceling all triggered scheduling information report(s) when the MAC CE is included in a MAC Protocol Data Unit (PDU). The MAC PDU is transmitted to a network terminal of the wireless communication system on a Contention Based (CB) uplink resource.

The present invention further discloses a communication device for handling scheduling information report in a user equipment (UE) of a wireless communication system. The communication device includes a processor for executing a program; and a memory coupled to the processor for storing the program. The program includes steps of triggering a scheduling information report, to generate a corresponding Medium Access Control Control Element (MAC CE), and keeping and not canceling all triggered scheduling information report(s) when the MAC CE is included in a MAC Protocol Data Unit (PDU). The MAC PDU is transmitted to a network terminal of the wireless communication system on a Contention Based (CB) uplink resource.

The present invention further discloses a method for handling scheduling information report in a user equipment (UE) of a wireless communication system. The method includes steps of triggering a first scheduling information report, to generate a corresponding Medium Access Control Control Element (MAC CE), including the MAC CE in a MAC Protocol Data Unit (PDU), and cancelling all triggered scheduling information report(s), transmitting the MAC PDU to a network terminal of the wireless communication system on a Contention Based (CB) uplink resource, and triggering a second scheduling information report when a transmission condition of the MAC PDU conforms to a predefined condition.

The present invention further discloses a communication device for handling scheduling information report in a user equipment (UE) of a wireless communication system. The communication device includes a processor for executing a program, and a memory coupled to the processor for storing the program. The program includes steps of triggering a first scheduling information report, to generate a corresponding Medium Access Control Control Element (MAC CE), including the MAC CE in a MAC Protocol Data Unit (PDU), and cancelling all triggered scheduling information report(s), transmitting the MAC PDU to a network terminal of the wireless communication system on a Contention Based (CB) uplink resource, and triggering a second scheduling information report when a transmission condition of the MAC PDU conforms to a predefined condition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system.

FIG. 2 is a function block diagram of a wireless communications device.

FIG. 3 is a schematic diagram of a program code of FIG. 2.

FIG. 4 is a schematic diagram of a process according to an embodiment of the present invention.

FIG. 5 is a schematic diagram of a process according to another embodiment of the present invention.

### DETAILED DESCRIPTION

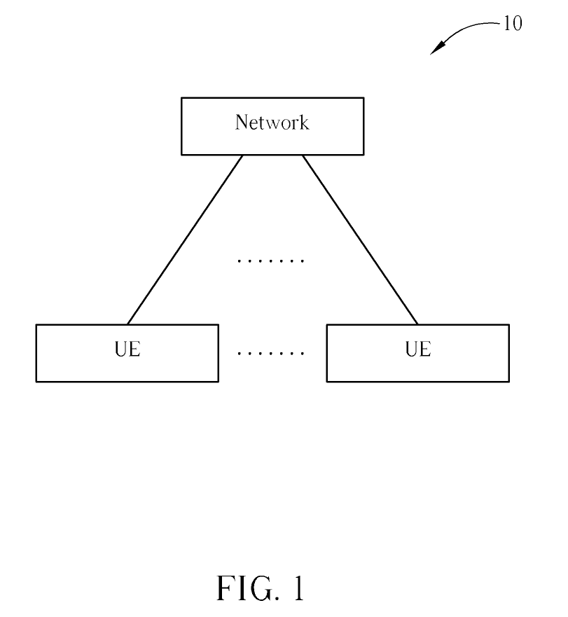

Please refer to FIG. 1, which is a schematic diagram of a wireless communications system 10. The wireless communications system 10 is preferred to be an LTE-advanced (LTE-A) system, and is briefly composed of a network and a plurality of user equipments (UEs). In FIG. 1, the network and the UEs are simply utilized for illustrating the structure of the wireless communications system 10. Practically, the network may comprise a plurality of base stations (Node Bs), radio network controllers and so on according to actual demands, and the UEs can be devices such as mobile phones, computer systems, etc.

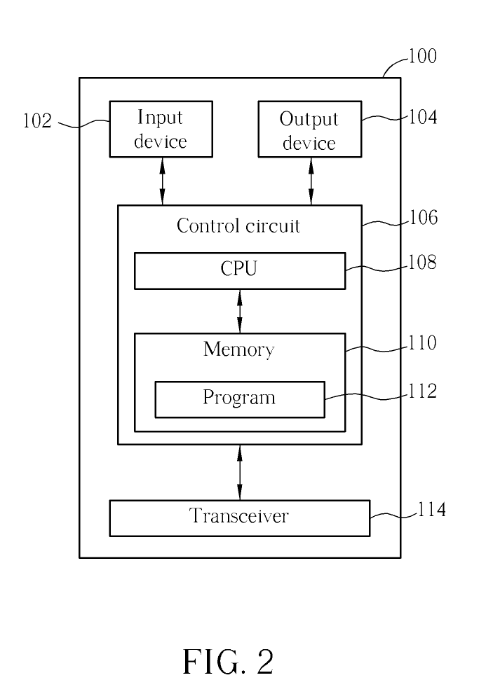

Please refer to FIG. 2, which is a functional block diagram of a communications device 100 in a wireless communications system. The communications device 100 can be utilized for realizing the network in FIG. 1. For the sake of brevity, FIG. 2 only shows an input device 102, an output device 104, a control circuit 106, a central processing unit (CPU) 108, a memory 110, a program 112, and a transceiver unit 114 of the communications device 100. In the communications device 100, the control circuit 106 executes the program code 112 in the memory 110 through the CPU 108, thereby controlling an operation of the communications device 100. The communications device 100 can receive signals inputted by a user through the input device 102, such as a keyboard, and can output images and sounds through the output device 104, such as a monitor or speakers. The transceiver unit 114 is used to receive and transmit wireless signals, for delivering received signals to the control circuit 106, and outputting signals generated by the control circuit 106 wirelessly. From a perspective of a communications protocol framework, the transceiver unit 114 can be seen as a portion of Layer 1, and the control circuit 106 can be utilized to realize functions of Layer 2 and Layer 3.

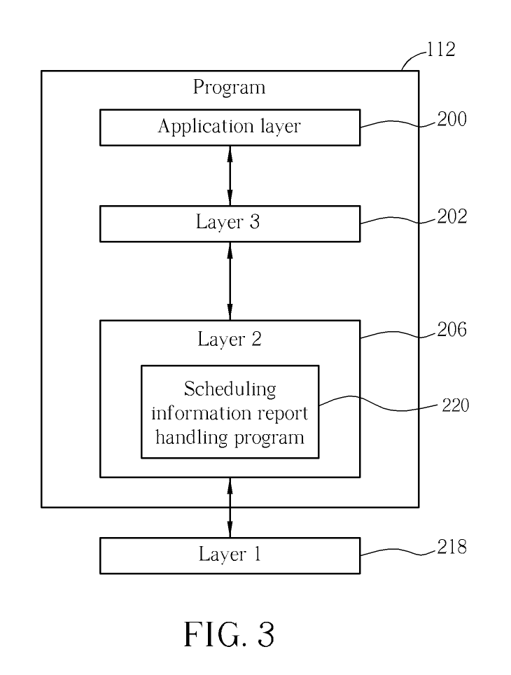

Please continue to refer to FIG. 3. FIG. 3 is a schematic diagram of the program 112 shown in FIG. 2. The program 112 includes an application layer 200, a Layer 3 202, and a Layer 2 206, and is coupled to a Layer 1 218. The Layer 3 202 performs radio resource control. The Layer 2 206 comprises a Radio Link Control (RLC) layer and a Medium Access Control (MAC) layer, and performs link control. The Layer 1 218 performs physical connections.

As can be seen from the prior art, the LTE-A system introduces Contention Based (CB) transmission, which allows synchronized UEs to contend for uplink transmission resources without sending SR in advance, so as to reduce user plane delay. In order to realize the CB transmission, the LTE-A system introduces a Contention Based Radio Network Temporary Identifier (CB-RNTI), for identifying CB uplink grants allocated by a network terminal to a UE on a Physical Downlink Control Channel (PDCCH). Correspondingly, the UE should generate a unique UE identifier, and include the unique UE identifier in a MAC Protocol Data Unit (PDU), which is transmitted to the network terminal on a CB uplink resource, such that the UE can be identified. The MAC PDU can further include a buffer status report (BSR) or a Power Headroom Report (PHR), for reporting scheduling information of the UE, such as an uplink buffer status or a power usage status, to the serving network terminal, such that the network terminal can effectively allocate radio resources and perform scheduling decisions. Under such a situation, the embodiment of the present invention provides a scheduling information report handling program 220 in the MAC layer of the Layer 2 206, for properly transmitting scheduling information in a CB uplink transmission, so as to avoid waste of radio resources.

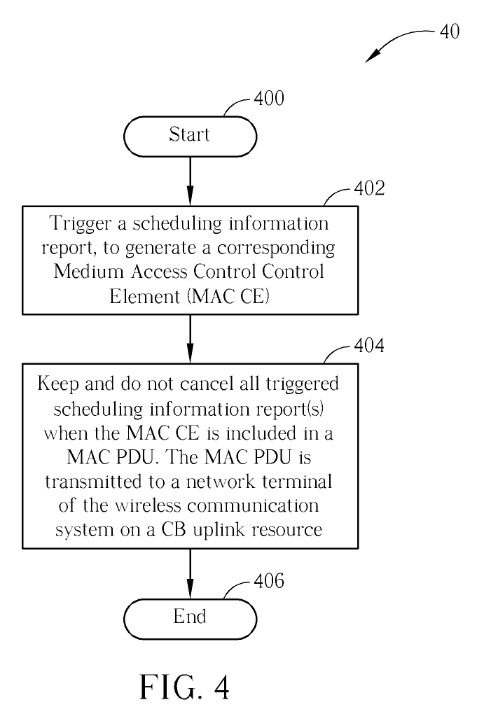

Please refer to FIG. 4, which is a schematic diagram of a process 40 according to an embodiment of the present invention. The process 40 is utilized for handling scheduling information report in a UE of a wireless communication system, and can be compiled into the scheduling information report handling program 220. The process 40 includes the following steps:

Step 400: Start.

Step 402: Trigger a scheduling information report, to generate a corresponding Medium Access Control Control Element (MAC CE).

Step 404: Keep and do not cancel all triggered scheduling information report(s) when the MAC CE is included in a MAC PDU. The MAC PDU is transmitted to a network terminal of the wireless communication system on a CB uplink resource.

Step 406: End.

According to the process 40, when a MAC PDU including a MAC CE corresponding to a scheduling information report is transmitted on a CB uplink resource, the embodiment of the present invention keeps and does not cancel all triggered scheduling information report(s). Preferably, the scheduling information report is not a padding BSR or PHR; that is, the scheduling information report can be a regular, periodic BSR, or a regular PHR. Therefore, taking a BSR as an example, after the network terminal allocates CB uplink resources to the UE on a PDCCH, the UE can transmit a MAC PDU including a BSR MAC CE on the CB uplink resource to the network terminal, such that the network terminal can determine an uplink buffer status of the UE. Under such a situation, the embodiment of the present invention does not cancel the triggered BSR(s). As a result, when the MAC PDU is unsuccessfully transmitted, e.g. due to data packet collision, since there is still triggered BSR (s), the UE can transmit a BSR again when receiving uplink resources next time, which ensures that uplink resources are correctly allocated, and maintains uplink transmission efficiency.

Noticeably, the above-mentioned BSR or PHR forms, such as regular, periodic, padding (a PHR does not include a periodic form), are specified in detail in the related specification (e.g. 3GPP TS 36.321 V8.6.0), and are well know in the industry. For example, a regular BSR is triggered when uplink data is available for transmission for a logic channel of a logic channel group and the logic channel has higher priority than other logic channels or no uplink data available for transmission for other logic channels, or is triggered when a retransmission timer“retxBSR-Timer” expires and the UE has uplink data available for transmission for any of the logic channels; a periodic BSR is triggered when a periodic BSR timer “PERIODIC BSR TIMER” expires; and a padding BSR is triggered when uplink resources are allocated to the UE, and number of padding bits of the MAC PDU is greater or equal to bits of the BSR MAC CE plus the corresponding subheader.

On the other hand, in the embodiment of the present invention, the network terminal allocates CB uplink resources to the UE on a PDCCH, so as to perform the CB uplink transmission, which is not related to Random Access Response message, also called Message 2 (Msg2) or Temporary Cell Radio Network Temporary Identifier, and should not be mistaken.

In the prior art, when a BSR is included in a MAC PDU, all triggering BSRs are cancelled, such that the UE has no BSR MAC CE available to be transmitted to the network terminal. Under such a situation, if the MAC PDU including the BSR cannot be transmitted successfully to the network terminal due to data packet collision, or the UE receives a more reliable uplink grant requested by SR procedure, since all triggered BSRs are cancelled, the UE cannot transmit the BSR MAC CE to the network terminal, such that the network terminal cannot determine a buffer status of the UE, causing delay of uplink resource allocation, or reduction of uplink transmission efficiency. In comparison, in the embodiment of the present invention, when a BSR (via a MAC CE) is included in a MAC PDU, triggered BSRs are not cancelled. As a result, the UE still has BSR MAC CE available to be transmitted to the network terminal, which avoids a drawback of the prior art. Accordingly, an example for a PHR can be readily derived.

Furthermore, when the UE receives an acknowledgement (ACK) corresponding to the MAC PDU, the UE can cancel all triggered BSRs or PHRs, to improve operating efficiency, and the ACK is preferably a message exclusive in the CB uplink transmission and not related to Hybrid Automatic Repeat reQuest (HARQ) procedure.

In short, by the process 40, when a BSR is included in a MAC PDU, the embodiment of the present invention does not cancel triggered BSRs.

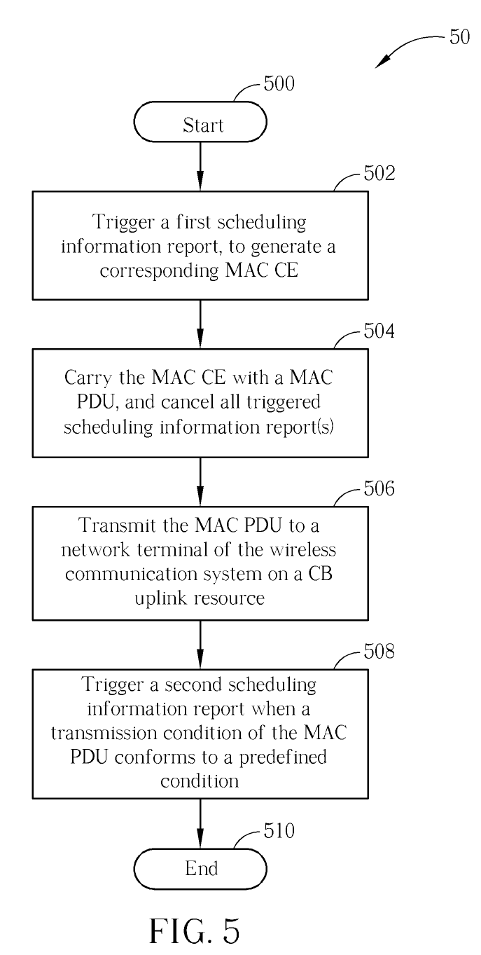

Furthermore, please refer to FIG. 5, which is a schematic diagram of a process 50 according to an embodiment of the present invention. The process 50 is utilized for handling scheduling information report in a UE of a wireless communication system, and can be compiled into the scheduling information report handling program 220. The process 50 includes the following steps:

Step 500: Start.

Step 502: Trigger a first scheduling information report, to generate a corresponding MAC CE.

Step 504: Carry the MAC CE with a MAC PDU, and cancel all triggered scheduling information report(s).

Step 506: Transmit the MAC PDU to a network terminal of the wireless communication system on a CB uplink resource.

Step 508: Trigger a second scheduling information report when a transmission condition of the MAC PDU conforms to a predefined condition.

Step 510: End.

According to the process 50, when a MAC CE corresponding to a scheduling information report is included in a MAC PDU, the embodiment of the present invention cancels all triggered scheduling information report(s), and triggers another scheduling information report according to the transmission condition of the MAC PDU. Preferably, the scheduling information report is not padding BSR or PHR; that is, the scheduling information report can be a regular, periodic BSR, or a regular PHR. Therefore, taking a BSR as an example, after the network terminal allocates CB uplink resources to the UE on a PDCCH, the UE can transmit a MAC PDU including a BSR MAC CE on the CB uplink resource to the network terminal, such that the network terminal can determine an uplink buffer status of the UE. Under such a situation, if the MAC PDU is not successfully transmitted, the embodiment of the present invention can trigger another scheduling information report. As a result, the present invention can ensure uplink resources are correctly allocated, and maintain uplink transmission efficiency.

Noticeably, the above-mentioned BSR or PHR forms, such as regular, periodic, padding (a PHR does not include a periodic form), are specified in detail in the related specification, and are well know in the industry. In addition, the predefined condition of the step 508 is preferably corresponding to a condition that the MAC PDU is not successfully transmitted, e.g. receiving a negative-acknowledgement (NACK) corresponding to a last retransmission of the MAC PDU or not receiving an ACK corresponding to the MAC PDU, which is not limited to this. Besides, the ACK is preferably a message exclusive in the CB uplink transmission and not related to HARQ procedure.

In the prior art, when a BSR is included in a MAC PDU, all triggered BSRs are cancelled, such that the UE has no BSR MAC CE available to be transmitted to the network terminal. In comparison, in the embodiment of the present invention, when the MAC PDU including an BSR is not successfully transmitted, the UE can trigger another BSR. As a result, the UE still has BSR MAC CE available to be transmitted to the network terminal, which avoids a drawback of the prior art. Accordingly, an example for a PHR can be readily derived.

In short, by the process 50, when a BSR is included in a MAC PDU, the embodiment of the present invention cancels all triggered BSRs, and timely triggers another scheduling information report according to the transmission condition of the MAC PDU.

To sum up, in the embodiment of the present invention, when a BSR or PHR is included in a MAC PDU, the UE can still have BSR or PHR available to be transmitted to the network terminal, so as to ensure uplink resources are correctly allocated, and maintain uplink transmission efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling scheduling information report in a user equipment of a wireless communication system, the method comprising:
triggering a scheduling information report, to generate a corresponding Medium Access Control Control Element (MAC CE); and
keeping and not canceling all triggered scheduling information report(s) when the MAC CE is included in a MAC Protocol Data Unit (PDU);
wherein the MAC PDU is transmitted to a network terminal of the wireless communication system on a Contention Based (CB) uplink resource.

2. The method of claim 1, wherein the scheduling information report is a regular or periodic Buffer Status Report.

3. The method of claim 1, wherein the scheduling information report is a regular Power Headroom Report.

4. The method of claim 1, wherein the CB uplink resource is allocated by the network terminal via a Contention Based Radio Network Temporary Identifier.

5. The method of claim 1, wherein the CB uplink resource is indicated by the network terminal on a Physical Downlink Control Channel.

6. The method of claim 1 further comprising cancelling all triggered scheduling information report(s) when receiving an acknowledgement corresponding to the MAC PDU.

7. A communication device for handling scheduling information report in a user equipment of a wireless communication system, the communication device comprising:
a processor for executing a program; and
a memory coupled to the processor for storing the program; wherein the program comprises:
triggering a scheduling information report, to generate a corresponding Medium Access Control Control Element (MAC CE); and
keeping and not canceling all triggered scheduling information report(s) when the MAC CE is included in a MAC Protocol Data Unit (PDU);
wherein the MAC PDU is transmitted to a network terminal of the wireless communication system on a Contention Based (CB) uplink resource.

8. The communication device of claim 7, the scheduling information report is a regular or periodic Buffer Status Report.

9. The communication device of claim 7, the scheduling information report is a regular Power Headroom Report.

10. The communication device of claim 7, wherein the CB uplink resource is allocated by the network terminal via a Contention Based Radio Network Temporary Identifier.

11. The communication device of claim 7, wherein the CB uplink resource is indicated by the network terminal on a Physical Downlink Control Channel.

12. The communication device of claim 7, wherein the program further comprises cancelling all triggered scheduling information report(s) when receiving an acknowledgement corresponding to the MAC PDU.

13. A method for handling scheduling information report in a user equipment of a wireless communication system, the method comprising:
triggering a first scheduling information report, to generate a corresponding Medium Access Control Control Element (MAC CE);
carrying the MAC CE with a MAC Protocol Data Unit (PDU), and cancelling all triggered scheduling information report(s);
transmitting the MAC PDU to a network terminal of the wireless communication system on a Contention Based (CB) uplink resource; and
triggering a second scheduling information report when a transmission condition of the MAC PDU conforms to a predefined condition.

14. The method of claim 13, wherein the first scheduling information report or the second scheduling information report is a regular or periodic Buffer Status Report.

15. The method of claim 13, wherein the first scheduling information report or the second scheduling information report is a regular Power Headroom Report.

16. The method of claim 13, wherein the predefined condition is receiving a negative-acknowledgement (NACK) corresponding to the MAC PDU.

17. The method of claim 16, wherein the NACK is corresponding to a last retransmission of the MAC PDU.

18. The method of claim 13, wherein the predefined condition is not receiving an acknowledgement corresponding to the MAC PDU.

19. The method of claim 13, wherein the CB uplink resource is allocated by the network terminal via a Contention Based Radio Network Temporary Identifier.

20. The method of claim 13, wherein the CB uplink resource is indicated by the network terminal on a Physical Downlink Control Channel.

21. A communication device for handling scheduling information report in a user equipment of a wireless communication system, the communication device comprising:
a processor for executing a program; and
a memory coupled to the processor for storing the program; wherein the program comprises:
triggering a first scheduling information report, to generate a corresponding Medium Access Control Control Element (MAC CE);
carrying the MAC CE with a MAC Protocol Data Unit (PDU), and cancelling all triggered scheduling information report(s);
transmitting the MAC PDU to a network terminal of the wireless communication system on a Contention Based (CB) uplink resource; and
triggering a second scheduling information report when a transmission condition of the MAC PDU conforms to a predefined condition.

22. The communication device of claim 21, wherein the first scheduling information report or the second scheduling information report is a regular or periodic Buffer Status Report.

23. The communication device of claim 21, wherein the first scheduling information report or the second scheduling information report is a regular Power Headroom Report.

24. The communication device of claim 21, wherein the predefined condition is receiving a negative-acknowledgement (NACK) corresponding to the MAC PDU.

25. The communication device of claim 24, wherein the NACK is corresponding to a last retransmission of the MAC PDU.

26. The communication device of claim 21, wherein the predefined condition is not receiving an acknowledgement corresponding to the MAC PDU.

27. The communication device of claim 21, wherein the CB uplink resource is allocated by the network terminal via a Contention Based Radio Network Temporary Identifier.

28. The communication device of claim 21, wherein the CB uplink resource is indicated by the network terminal on a Physical Downlink Control Channel.
